(19) United States
(12) Patent Application Publication
(10) Pub. No.: US 2003/0026974 A1
(43) Pub. Date: Feb. 6, 2003

(54) Resilient surface covering

(76) Inventors: Ronald S. Lenox, Lancaster, PA (US); Harry D. Ward, Lancaster, PA (US)

Correspondence Address: Womble Carlyle Sandridge & Rice, PLLC, P.O. Box 7037, Atlanta, GA, 30357-0037, US

(21) Appl. No.: 09/853,291

(22) Filed: May 11, 2001

(51) Int. Cl. B32B 27/00

(52) U.S. Cl. 428/319.3; 428/319.7; 442/320; 442/370

(57) ABSTRACT

A resilient surface covering, including a melt-processed layer, having improved impact resistance properties is provided herein. The melt-processed layer is formed, in part, of either a non-polyvinyl chloride resin, or a blend of a polyvinyl chloride resin and a compatible polymer, such as nitrile rubber, which imparts improved toughness characteristics to the layer. The increased toughness of the melt-processed layer consequently imparts improved impact resistance to the surface covering of which it is a part as compared to a control surface covering having a control layer formed only of a conventional melt-processed polyvinyl chloride resin.

### BACKGROUND

I. Field of the Invention

The present invention relates to resilient surface coverings, and particularly to resilient floor coverings having an enhanced impact resistance property.

II. Background of the Invention

Multi-layered polymeric sheets have been widely used as resilient surface coverings, especially to cover floors. One problem that arises from use of such polymeric sheets is damage due to object impact thereon, which, depending on the nature of the forces involved, may permanently mar the sheet. Some multi-layer resilient surface coverings include melt-processed base layers formed of resins composed of polyvinyl chloride (PVC) homopolymers, which provide strength and durability to the surface covering sheet. The PVC resins used in these melt-processed base layers typically have molecular weights corresponding to K Values of about 62-71, wherein K Values are defined at page 95 of the Handbook of PVC Formulating, edited by Edward J. Wickson, published by John Wiley & Sons, 1993 copyright. The melt-processed base layers formed of these PVC resins typically do not include any other strength-imparting polymers besides PVC homopolymers. Past efforts at improving the impact resistance of resilient floor coverings have tended to increase the thickness and/or weight of the coverings. Thus, it is desirable to provide a means for enhancing the impact resistance property of a surface covering so that either increases in the impact resistance property are obtained with current levels of thickness and weight, or reductions in thickness and weight are possible while maintaining current levels of the impact resistance property.

### SUMMARY OF THE INVENTION

Resilient surface coverings and surface covering components, particularly suitable for use as floor coverings and components thereof, and methods of making these, are disclosed. In one embodiment, the surface covering or surface covering component includes a melt-processed layer adhered to a substrate, and, optionally, may include one or more layers directly or indirectly overlying and/or adhered to the melt-processed layer, such as a foamed or foamable layer, a patterned layer, a wear layer, and a top coat layer.

In another embodiment, the surface covering or surface covering component includes a melt-processed layer adhered to either a foamed or foamable layer, a wear layer, a patterned layer, a top coat layer or similar layer. This embodiment may also include one or more additional layers, similar to or differing from those layers described above, directly or indirectly overlying and/or adhered to the layer adhered to the melt-processed layer. Furthermore, this embodiment may also include a substrate adhered to the melt-processed layer on the side thereof which is not adhered to the other layer.

In yet another embodiment, the surface covering or surface covering component includes a substrate adhered to a melt-processed layer and at least one additional layer overlying and/or adhered to the substrate opposite the surface thereof which is in contact with the melt-processed layer.

The melt-processed layer may be formed from a polymer or polymeric blend that exhibits improved toughness relative to a control layer having, as its only strength-imparting polymeric component, a polyvinyl chloride resin, typically used in surface coverings, with a molecular weight corresponding to a K Value of about 62-7 1. The toughness value of a melt-processed layer of the invention may be 100% greater than that of a comparable control layer having a PVC resin, with a K Value of about 62-71, as its only strength-imparting polymeric component, each of such toughness values being calculated from the results of empirically determined ultimate tensile strength and percent elongation test(s) for each tested sheet layer. Examples of suitable polymers for use in preparing the melt-processed layer of the invention include melt-processable polymers, other than PVC, with a K Value of about 62-71, such as ethylene-vinylacetates, ethylene-propylene-dienes, polyethylene-propylenes, urethanes, polyesters, acrylonitriles, styrene-butadienes and co-polymers and blends thereof. Furthermore, suitable polymers that may serve as some of the components of the melt-processed layer include, for example, at least one blend containing both polyvinyl chloride and at least one compatible polymer. Examples of compatible polymers include acrylonitriles, urethanes, ethylene-vinyl-acetates, chlorinated polyethylenes, polyesters, co-polymers and blends thereof. These melt-processable polymers and polymeric blends impart increased toughness to the melt-processed layer, when compared to a melt-processed layer having a conventional PVC resin as its only strength-imparting polymeric component. Furthermore, the melt-processed layer also provides a greater impact resistance value for a surface covering of which it is a part, when compared to a control surface covering including a layer having a conventional PVC resin as its only strength imparting polymer component, such values for impact resistance being empirically determined using a test, such as a can drop test, as discussed below. The resulting enhanced properties of the melt-processed layers and surface coverings of the instant invention may lead to either increased impact resistance at current levels of thickness and weight, or reduced levels of thickness and weight at current levels of impact resistance. These and other advantages of the surface coverings and surface covering components of the present invention are set forth herein.

### DETAILED DESCRIPTION OF THE INVENTION

Reference will now be made in detail to certain embodiments of the instant invention. Each example is provided by way of explanation of the invention, and is not meant as a limitation of the invention. For example, features illustrated or described as part of one embodiment can be used on or in conjunction with other embodiments to yield yet a further embodiment. It is intended that the present invention includes such modifications and variations. The materials and process steps used to form the surface coverings and surface covering components are well known in the art. However, those skilled in the art have not used the combination of materials and process steps in the order of the present invention to improve the impact resistance of a surface covering or surface covering component as measured, for example, by the can drop test described herein.

The present invention provides resilient surface coverings and surface covering components, especially apt for covering floors, having certain enhanced properties as compared to conventional resilient surface coverings and surface covering components. The enhanced properties may include, among others, the impact resistance of a surface covering and the toughness of a melt-processable layer. The impact resistance of a surface covering relates to its ability to withstand impacts from objects striking the sheet without the sheet sustaining deformations therefrom, while toughness relates to the total energy absorbed by the sheet. The impact resistance of a sheet may be determined using a can drop test, or similar test method, as discussed below. The toughness of a layer may be calculated by conducting ultimate tensile strength and percent elongation test(s) on the layer. An example of tensile strength and percent elongation test are set forth below.

The enhancements in the aforementioned properties are determined by comparison of the surface covering and/or melt-processed layers of the present invention with control surface coverings and control melt-processed layers, such control surface coverings optionally being formed with control melt-processed base layers having polyvinyl chloride as the only strength-imparting polymer, as discussed below. The word resilient connotes the ability to recover from deformation, such as indentations created by a shoe heel, table leg, falling object and the like. This ability to recover distinguishes resilient floor coverings from other coverings such as carpeting, wood, ceramic and stone. The enhanced impact resistance and toughness is provided by a melt-processed layer composed of a melt-processable polymeric matrix material that includes at least one strength-imparting non-PVC polymer that serves as a complete or partial substitute for the PVC resin known in the art. The melt-processed layer may also include filler material. The polymeric matrix material provides improved toughness characteristics to the layer, thereby enhancing the impact resistance of the overall multi-layered covering of which it is a part.

The present invention covers both surface covering components, and resilient surface coverings of which such components may be a part. The surface covering component includes a melt-processed layer, which may serve as the base layer of such a resilient surface covering. The melt-processed layer may be formed of a filler and a melt-processable matrix material including one or more strength-imparting polymers. The filler may include any well-known material such as clay, dolomite, talc and limestone, typically in the range of about 55% to about 85% by weight. The strength-imparting polymers may be one or more of, for example, an ethylene-vinyl acetate, an ethylene-propylene-diene, a polyethylene-propylene, a urethane, a polyester, an acrylonitrile, a styrene-butadiene, and a co-polymer thereof. Alternatively, the strength-imparting polymer may be a polymeric blend of polyvinyl chloride and one or more compatible polymers, such as, for example, an acrylonitrile, a urethane, an ethylene-vinyl-acetate, a chlorinated polyethylene, a polyester, and a co-polymer thereof. The term “compatibility” is used, in the strict technological sense, to describe whether a desired beneficial result occurs when two polymers are combined. For each polymer and blend thereof, there will be an optimum mixture that provides maximum toughness and impact resistance. Combinations that provide such optimum toughness and impact resistance can be readily determined using no more than routine experimentation, for example, using the can drop and other tests described herein or otherwise known to those of skill in the art. Those combinations providing a significant improvement in impact resistance (about 30% or greater, as measured by the can drop test described herein) and/or a significant increase in toughness as defined herein (100% or greater) are intended for use in preparing the melt processed layers. In one embodiment, the blend includes 25%/75% by weight of nitrile rubber to PVC for a 60% filled base layer composition. Unblended polymers that provide these improvements are also intended for use in preparing the melt-processed layers. While the various polymers and polymeric blends will impart a range of toughness and impact resistance values to the surface coverings and surface covering components of which they are a part, the present invention encompasses only those surface coverings each of which exhibits an impact resistance value of at least about 30% or greater than that exhibited by a control surface covering to which it is compared, and surface covering components and/or surface coverings having melt-processable layers each of which exhibits a toughness value of at least about 100% or greater than that exhibited by a control melt-processed PVC layer to which it is compared.

As used herein, a control melt-processed PVC layer is a melt-processed layer well known in the art, typically used and known as a base layer, having a thickness, filler type and percent filler content by weight equal to that of the melt-processed layer of the present invention to which it is compared. These properties of thickness, filler type and percent filler content are referred to herein as equivalent properties for solid/unfoamed base layers. For foamed base layers, the thickness, foam blow ratio, and filler type and content are referred to herein as equivalent properties for foamed base layers. The only strength-imparting polymer included in the control melt-processed PVC layer is a polyvinyl chloride homopolymer with a K Value of about 62-71. The amount and type of the stabilizers, plasticizers, processing aids and other minor constituents of the control melt-processed PVC layer may vary from those found in the compared melt-processed layer of the present invention. The control melt-processed PVC base layer is melt-processed according to methods and under conditions well known in the art, which may be either identical to or vary from those process methods and conditions by which the compared melt-processed layer of the invention is formed. However, in each instance, a control melt-processed PVC layer has either solid or foamed equivalent properties identical to those of the melt-processed layer of the present invention to which it is compared. For example, in the case of an unfoamed melt-processed layer of the present invention having a thickness of 10 mils and 60% by weight of a particular type of limestone filler, the control melt-processed PVC layer will, likewise, be unfoamed and have a thickness of 10 mils and include 60% by weight of the same type of limestone filler. The resin composition of the control melt-processed PVC layer will vary from that of the melt processed layer of the invention in this example, while other characteristics, such as plasticizer type, may or may not vary from those of the melt-processed layer. Alternatively, in another example, for an unfoamed melt-processed layer of the instant invention with a thickness of 20 mils and 70% by weight of a particular type of limestone filler, the control melt-processed PVC layer will be unfoamed and have a thickness of 20 mils and 70% by weight of the same type of limestone filler.

Additionally, as used herein, a control surface covering includes layers, excluding the base layer, identical to those found in the surface covering of the present invention. Besides the base layer, these layers of the control surface covering are composed of the same materials, processed by the same methods, and have the same dimensions as those corresponding layers of the surface covering of the invention. The control surface covering differs from a surface covering of the instant invention to which it is compared only in having a base layer which is a control melt-processed PVC layer as set forth hereinabove. The control melt-processed PVC layer, serving as the base layer of the control surface covering, exhibits the equivalent properties found in the base layer of the sheet of the present invention. However, the base layer of the sheet of the present invention is a melt-processed layer including a non-PVC strength-imparting polymer as described above. Therefore, for example, when a surface covering of the invention having a 10 mil wear layer formed of a first plastisol adhered to a 20 mil foam layer formed of a second plastisol adhered to a 30 mil unfoamed melt-processed base layer with a 80% by weight of a particular limestone filler adhered to a 20 mil beater-saturated felt substrate is compared to a control surface covering, the control surface covering includes a 10 mil wear layer formed of the first plastisol adhered to a 20 mil foam layer formed of the second plastisol adhered to a 30 mil unfoamed control melt-processed PVC base layer with an 80% by weight of a particular limestone filler adhered to a 20 mil beater-saturated felt substrate. The difference between the surface covering of the present invention and the control surface covering in this example lies in the compositions of the control melt-processed PVC layer and the melt-processed base layer, and, possibly, the processing parameters by which this control melt-processed PVC base layer was prepared, since the control melt-processed PVC base layer is limited to containing as the only strength-imparting polymer a polyvinyl chloride homopolymer resin with a K Value of about 62-71.

The surface covering of the invention may be formed, in part, of a melt-processed layer, as described above, and one or more other layers. For example, the melt-processed layer may be adhered to a substrate by any well-known method. The substrate may be any such layer well-known in the art. Substrates for surface coverings are well known in the art. Some examples of substrates are solid, filled or unfilled polymeric layers or composites, solid layer composites comprising fibrous webs saturated with polymeric binder, and one or more porous fibrous layers such as beater-saturated felts, and non-woven fabric materials.

Such a surface covering may optionally include one or more other layers, known in the art, directly or indirectly adhered to the melt-processed layer, including a foamed or foamable layer, a wear layer, a patterned layer, or a top coat layer. These layers may be formed of various well-known materials, and may contain blowing agents and chemical embossing agents. Some examples of such other layers are described, but not limited to, those in U.S. Pat. Nos. 3,655,312; 3,887,678; 3,953,639; 3,293,108; 3,574,659; 3,607,341; 4,230,759; 4,193,957 and 5,643,677 and incorporated herein by reference in their entireties.

An embodiment of the present invention may include a surface covering including three layers. This multi-layered component has a melt-processed base layer adhered to a foamed inner layer, which, in turn, is adhered to a wear layer. The melt-processed base layer, foamed inner layer and wear layer may be integrally formed in a hot-melt-calendering process or another process, which process may be well known in the art. The base layer is, being the melt-processed layer of the instant invention, formed, in part, of a matrix material, including a strength-imparting polymer, other than polyvinyl chloride with a K Value of about 62-71, such as nitrile rubber, or other polymers listed above. Typically, the wear layer is approximately about 8-30 mils thick and the foamed inner layer is about 9-80 mils thick. More typical values for the thickness of the wear layer and the foamed inner layer are about 10-20 mils and 10-50 mils, respectively. The wear layer and/or the foamed layer may be formed of a PVC plastisol, well known in the art, and can include plasticizers such as, for example, butyl cyclohexyl phthalate, tri(butoxyethyl) phosphate, trioctyl phosphate, 2-ethylhexyl diphenyl phosphate, dibutyl phthalate, diisobutyl adipate, epoxidized di(2-ethylhexyl) tetrahydrophthalate, di(2-ethylhexyl) phthalate, diiusooctyl phthalate, dioctyl adipate, diisononyl phthalate, di(2-ethylhexyl) hexahydrophthalate, n-octyl,n-decyl phthalate, tricresyl phosphate, butyl benzyl phthalate, dicapryl phthalate, di(3 ,5 ,5-trimethylhexyl) phthalate, diisodecyl phthalate, di(2-ethylhexyl) adipate, butyl epoxy stearate, epoxidized soya oil, epoxidized octyl tallate, dimethyl phthalate, hexyl epoxy stearate, cresyl diphenyl phosphate, di(2-ethylhexyl) isophthalate, n-octyl,n-decyl adipate, di(2-ethylhexyl) azelate, epoxidized octyl oleate, di(2-ethylhexyl) sebacate, tetraethylene glycol/di(2-ethylhexoate), diisodecyl adipate, and triethylene glycol/di(2-ethylhexoate). The base layer of such a resilient surface covering is typically about 10-60 mils, and more typically about 20-40 mils, in thickness and disposed below the wear layer of the surface covering or surface covering component. However, the base layer of the instant invention may be thinner than these typical ranges, since it exhibits a toughness value that markedly exceeds values exhibited by conventional PVC base layers, thereby potentially providing equal toughness in a thinner layer.

Another embodiment of the invention includes a substrate attached to the other layers of the surface covering. The substrate may be formed of a beater-saturated felt or other non-woven polymeric material and integrally formed with the base layer during the calendering process. The substrate may be composed of glass, polyester or other well known fibers and formed into a non-woven web by methods typical to the industry, such as, for example, those components and methods described in the “Wellington Sears Handbook of Industrial Textiles” by SabitAdanur, Technomic Publishing Co., Inc., Lancaster, Pa. 1995, pp 141-158.

One embodiment of the melt-processed layer of the present invention includes a limestone filler and a matrix material containing a blend of PVC and nitrile rubber. Since nitrile rubber is compatible with PVC, the two polymers may be provided in resin form and blended on a molecular level during hot melt processing. A surface covering including, as its base layer, a melt-processed layer containing a blend of nitrile rubber and PVC, is processed by first forming the base layer via melt processing. The components of the base layer include a powdered PVC resin, a powdered, crumb, or particulate nitrile rubber, which may be partially cross-linked, at least one plasticizer, stabilizers, processing aids and filler. The dry components are mixed together, and then the liquid components are added over a period of time while stirring. During stirring, the temperature of the mixture is increased to approximately 82° C. (180° F.). The resulting blend is a dry, fluffy, free flowing mixture termed a “dry blend.” The dry blend is then dumped into a cooling bin and allowed to cool to approximately 38° C. (100° F.) with stirring. The cooled dry blend is then transferred to a holding bin.

Alternatively, the base layer components may be processed in such a manner as to form a “wet blend.” As with the dry blend, all dry components are initially mixed together and then the liquid components are added over a period of time with stirring. However, during this mixing step the mixture temperature is held below about 38° C. (100° F.). The resulting moist mixture is termed a “wet blend.” The wet blend is then moved to a holding bin for further processing.

Either the dry blend or the wet blend may be used in the next mixing procedure. The blended base layer material, either in dry blend or wet blend form, is fed into an intensive mixer, such as a Buss Kneader or a Farrel Continuous Mixer, where it is subjected to applied heat and shear action, resulting in the melting or fluxing of the matrix material. The fluxing matrix material thereby coats the filler particles, resulting in a homogenous molten blend whose temperature may range from about 160° C. (320° F.) to about 232° C. (450° F.). The temperature range is dependent on process characteristics such as mixer volume, throughput rate and applied shear. The mixture may be prone to thermal degradation, if overexposed to heat, or insufficient flux, if underexposed.

Once the base layer material has been sufficiently mixed, the base and additional layers are formed in a calendering process. The hot base layer mixture is introduced into the nip of a calender roll from where it is distributed across the width of the roll. The first and subsequent calender rolls grab the base layer mixture and form it into a sheet whose thickness is approximately equal to the gap between the rolls of the calender. The hot base layer sheet is applied via a pressure roll to a backing sheet formed of felt. The composite sheet of backing and base layer is then run over cooling rolls and wound up.

In order to apply the foamed inner layer to the composite backing/base layer sheet, the composite sheet is unrolled and fed into a reverse roll coater where an appropriate amount of a foamable plastisol is applied. The plastisol is preferably formed of PVC resin and a solid blowing agent, such as azobisformamide, which decomposes and forms a gas at elevated temperatures. The gas is trapped in the plastisol, thereby foaming the layer. Once the layer is foamed, the plastisol is gelled by applying heat. The composite sheet is rolled about a heated drum, with the plastisol contacting the drum. The drum may be heated to about 149° C. (300° F.) in order to supply heat sufficient to gel the plastisol, but insufficient to decompose the blowing agent. The composite sheet is then cooled and rolled for introduction to a printing press. The rolled composite sheet, which now includes a gelled layer, a base layer and a backing layer, is fed into a printing press or other decoration device in order to apply the desired colored ink pattern. Once inks are applied and dried, the composite sheet is then rolled and directed to further processing.

The upper or wear layer is applied to the composite sheet by unwinding the sheet and coating it with a non-foamable unfilled plastisol composition with a reverse roll coater. The plastisol is formed of PVC or other suitable resin. Heat is then applied to the composite sheet in order to fuse the unfoamed plastisol into a clear flexible solid layer and to foam and fuse the gelled plastisol layer. Application of heat may be accomplished by feeding the composite sheet through an oven at temperatures approaching about 204° C. (400° F.). Once the wear layer has fused and the gelled layer has foamed and fused, the multi-layer floor covering sheet may be cooled and rolled up. The resulting resilient surface covering sheet exhibits increased impact resistance values when compared to a control sheet. Melt-processed or preformed films or composite films may be used as wear layers and may be laminated to or melt-coated onto the composite sheet.

### EXAMPLES

The present invention may be better understood from the following examples, which are offered to illustrate the instant invention and not to limit it. All parts and percentages are by weight unless otherwise indicated.

All the examples were prepared by blending the materials in a mixer and subjecting them to increased temperatures and pressures similar to the procedure set forth hereinabove.

### Comparative Layer Examples

The comparative layer examples (CE—) served as the control melt-processed PVC layers for purposes of comparison of tensile strength, elongation and toughness with the melt-processed layer examples herein. The comparative layer examples each had formulations containing no nitrile rubber, whereas all examples of the instant invention compared thereto did include nitrile rubber. CE-60, CE-75 and CE-80 are unfoamed layers, which include PVC resin as the sole strength-imparting polymer within the layer. CE-60 contains 60% by weight of limestone filler. Likewise, CE-75 and CE-80 include 75% and 80%, respectively, of limestone filler. Table 1 illustrates the formulations on a percentage by weight basis of the comparative layer examples. In each of the comparative examples, Oxy 225 SG-K Value of 66, manufactured by OXY CHEM, was the PVC resin used. Jay flex 77, manufactured by EXXON MOBIL, was the plasticizer used in each comparative example. Likewise, each of CE-60, CE-75 and CE-80 included ESO, manufactured by FERRO Corporation, which served as a stabilizer for the layers. These comparative layer examples also included other well-known processing aids. Whereas CE-60 was made to a thickness of 25 mils (0.025 in.), CE-75 and CE-80 were formed to a thickness of 20 mils (0.02 in.).

TABLE I
Comparative Layer Example Formulations (percent by weight)

| Materials | CE-60 | CE-75 | CE-80 |
|---|---|---|---|
| PVC Resin | 26.0 | 16.3 | 13 |
| Plasticizer | 10.4 | 6.5 | 5.2 |
| Stabilizer | 0.8 | 0.5 | 0.4 |
| Processing Aids | 2.7 | 1.7 | 1.4 |
| Filler | 60.0 | 75 | 80 |

Melt-Processed Layer Examples

Melt-processed layer examples (E-) of the instant invention were prepared by similar methods using similar constituents to those found in the comparative layer examples, except for the replacement of a portion of the PVC resin with nitrile rubber resin. The nitrile rubber resins used in the examples included Chemigum P83, manufactured by Goodyear Chemical, and Zealloy DP 5178, manufactured by Zeon Chemicals Inc. The five example melt-processed layer formulations containing nitrile rubber are labeled E-60-12, E-60-25, E-60-37, E-75-15 and E-80-15. E-60-12, E-60-25 and E-60-37 each contained 60% by weight limestone filler and 26% by weight resins, including PVC resin and nitrile rubber resin. Whereas CE-60 contains 26% PVC resin, a portion of the PVC resin has been replaced by nitrie rubber in each of E-60-12, E-60-25 and E-60-37 on a basis of 12%, 25% and 37%, respectively, of the total amount of resin present in the formulations. Each of E-75-15 and E-80-15 have had 15% of the total PVC resin content found in CE-75 and CE-80, respectively, replaced with nitrile rubber.

TABLE II
Example Base Layer Formulations (percent by weight)

| Materials | E-60-12 | E-60-25 | E-60-37 | E-75-15 | E-80-15 |
|---|---|---|---|---|---|
| PVC Resin | 22.80 | 19.52 | 16.38 | 13.81 | 11.05 |
| Nitrile Rubber | 3.12 | 6.48 | 9.62 | 2.44 | 1.95 |
| Resin | | | | | |
| Plasticizer | 10.40 | 10.40 | 10.40 | 6.50 | 5.20 |
| Stabilizer | 0.80 | 0.80 | 0.80 | 0.50 | 0.40 |
| Processing Aids | 2.70 | 2.70 | 2.70 | 1.69 | 1.35 |
| Filler | 60.00 | 60.00 | 60.00 | 75.00 | 80.00 |

Each of the examples and comparative examples was tested for tensile strength and total elongation.

Tensile strength, percent elongation and toughness values were determined by the following procedure. An Instron/Instru-Met ReNew machine was employed that was equipped with Test Works 3.04 software from MTS/Syntec. The samples identified above were prepared in thicknesses ranging from about 21-26 mils, widths of 1 inch wide, and lengths of 6 inches. The 6 inch samples were mounted into the Instron with a jaw separation of 4 inches (1 inch of each sample end was held by the Jaw mount). The Instron tensile test was run at 4.00 inches a minute crosshead speed, and a stress/strain curve was obtained for each sample. The maximum load and percent elongation were determined by the software. Additionally, the software also calculated the total energy absorbed (TEA), which is equal to the energy-to-break divided by length times width. To calculate toughness, the TEA was divided by the thickness of the sample and is reported in Table III.

TABLE III
Tensile Strength, Elongation and Toughness Results for Examples

| | Tensile Strength | Elongation | | % |
|---|---|---|---|---|
| Example | Max. load (psi) MD | Total elongation (%) MD | Toughness | Improvement |
| CE-60 | 763.49 | 55.70 | 27.82 | |
| E-60-12 | 637.99 | 73.90 | 30.00 | 10 |
| E-60-25 | 592.22 | 168.0 | 59.05 | 112 |
| E-60-37 | 444.73 | 134.6 | 36.00 | 30 |
| CE-75 | 297.19 | 14.30 | 3.00 | |
| E-75-15 | 404.75 | 44.20 | 13.64 | 350 |
| CE-80 | 303.11 | 1.20 | 0.23 | |
| E-80-15 | 496.41 | 2.90 | 0.93 | 300 |

As indicated in Table III, the sample base layers of the present invention (E-60-25, E-75-15, E-80-15) exhibit toughness values at least 100% greater than the toughness values displayed by the equivalent PVC base layers (CE-60, CE-75, CE-80). The blend of nitrile rubber and PVC in the base layers of the instant invention provides increased elongation and toughness when compared to conventional PVC base layers.

Example Surface Coverings

Surface coverings were also formed using some of the formulations set forth in the melt-processed layer examples and comparative layer examples. In each case, a multilayer sheet was fabricated with a base layer with a thickness of 25 mils (0.025 in.) and 60% by weight filler content according to either the E-60-25 melt-processed layer example or the CE-60 comparative layer example described above. A PVC plastisol inner foamed layer and a 10 mil PVC plastisol wear layer according to known methods was adhered to each of these base layers. An equivalent felt layer was also bonded to the side of the base layer opposing the inner foamed layer. The thickness of the inner foamed layer varied from 17 mils (0.017 in.) to 50 mils (0.050 in.). These sample surface coverings were then subjected to the “can drop” test, the results of which are set forth in Table IV.

Impact resistance values for both a surface covering of the present invention and a control sheet are determined by subjecting each to a “can drop” or similar test, an example of which is described in U.S. Ser. No. 09/234,887 and incorporated herein by reference in its entirety. The can drop test simulates the type of impact on the wearing surface of a floor covering which might result from the dropping of heavy objects, such as filled food and beverage cans, thereon. A projectile weighing about 368.5 g (or 13 oz.) and having a core-hardened steel edge, which is similar to the point of contact of the edge of a metal can, is mounted with two ball bearing rollers on a vertical projectile guide. An indexing pointer is mounted on the front of the projectile to indicate the height of drop. Two parallel flat metal upright posts, approximately 63 inches long, guide the projectile. These posts are mounted perpendicular to the steel base plate. A scale, graduated in increments of 0.25 in., is mounted on one upright post for the purpose of indicating the drop height. A 5.875 in.×5.875 in. piece of 0.25 in. tempered Masonite, on which the specimen is placed during the test, is laid loose in a recessed area on the steel base plate, with the rough side of the piece of Masonite up. A Flash-Q-Lens Magnifier or equivalent magnification device is employed to examine the evidence of failure of the specimen.

A minimum of three specimens are cut, approximately 4 in. in the across the machine direction by 6 in. in the machine direction. A specimen is placed with the wearing surface up on the Masonite base. The projectile is dropped with its length parallel to the machine direction. Three determinations are made. The projectile is dropped from heights divided into 10 in. increments until failure occurs. Failure is defined as any cracking, cutting or separation that can be seen after close visual examination, which may be facilitated by the use of a magnifying device. Once failure occurs at a particular height, three drops are made at the same height. If three failures occur at a particular height, then the projectile is lowered 5 in.. Drops are carried out at progressively lower heights, in 5 in. increments, until three passing tests are obtained at a given height. The reported height is the highest point having three passes.

If less than three failures occur at a given height, then the projectile is raised in 5 in. increments and dropped, until three failures occur, followed by lowering until three passes are obtained. The specimen is shifted between each drop so that no more than one impact occurs at a given point on the sample. The results of the tests are reported in inches. For example, a can drop value, or impact resistance value, of 20 in. indicates that 20 in. is the greatest height at which 3 passing tests occurred for that specimen.

TABLE IV
Impact Resistance For Sample Surface Coverings (10 mil wear layer)

| | | | Percent Increase In |
|---|---|---|---|
| | | Impact Resistance | Impact Resistance |
| Base | Foamed Inner Layer | Can Drop Height | over Equivalent PVC |
| Layer | Thickness (in.) | (in.) | Base Layer |
| CE-60 | 0.017 | 30 | — |
| E-60-25 | 0.017 | 45 | 50 |
| CE-60 | 0.026 | 30 | — |
| E-60-25 | 0.026 | 50 | 66.7 |
| CE-60 | 0.05 | 45 | — |
| E-60-25 | 0.05 | 60 | 33.3 |

As indicated in Table IV, the sample surface coverings formed with the melt-processed base layer of the instant invention exhibited an impact resistance value, as indicated by the E-60-25 values, at least about 30% greater than the impact resistance value exhibited by a control sheet formed of a control melt-processed PVC base layer, as indicated by the CE-60 values. Even when the thickness of the foam inner layer was varied, the sheet of the present invention still displayed an enhanced impact resistance value as compared to that of a control sheet containing only a conventional PVC resin base layer.

With respect to the above description, it is to be realized that the optimum dimensional relationships for the parts of the invention, to include variations in size, materials, shape, form, function and manner of operation, assembly, and use, are deemed readily apparent and obvious to one skilled in the art, and all equivalent relationships described in the specification are intended to be encompassed by the present invention. Further, the various components of the embodiments of the present invention may be interchanged to produce further embodiments and these further embodiments are intended to be encompassed by the present invention. Although the invention has been described in detail for the purpose of illustration, it is understood that such detail is solely for that purpose, and variations can be made therein by those skilled in the art without departing from the spirit and scope of the invention, which is defined by the following claims.

What is claimed is:

1. A resilient surface covering or surface covering component comprising:
a wear layer adhered to a foamed layer, and a melt-processed layer adhered to said foamed layer, said melt-processed layer exhibiting a toughness value of at least 100% greater than a toughness value exhibited by a control melt-processed PVC layer.

2. The resilient surface covering or surface covering component of claim 1, wherein the melt-processed layer includes a polymeric blend.

3. The resilient surface covering or surface covering component of claim 2, the melt-processed layer including from about 10% to about 45% by weight of the polymeric blend.

4. The resilient surface covering or surface covering component of claim 2, the polymeric blend including a polyvinyl chloride polymer and at least one compatible polymer.

5. The resilient surface covering or surface covering component of claim 4, wherein the compatible polymer is molecularly soluble with said polyvinyl chloride polymer.

6. The resilient surface covering or surface covering component of claim 4, the compatible polymer being selected from the group consisting of an acrylonitrile, a urethane, an ethylene-vinyl-acetate, a chlorinated polyethylene, a polyester, and a co-polymer thereof.

7. The resilient surface covering or surface covering component of claim 4, the polymeric blend including about 10% to about 40% by weight of the compatible polymer.

8. The resilient surface covering or surface covering component of claim 1, further comprising a substrate adhered to the melt-processed layer.

9. The resilient surface covering or surface covering component of claim 1, the melt-processed layer including at least one polymer selected from the group consisting of an ethylene-vinyl-acetate, an ethylene-propylene-diene, a polyethylene-propylene, a urethane, a polyester, an acrylonitrile, a styrene-butadiene, and a co-polymer thereof.

10. The resilient surface covering or surface covering component of claim 2, the polymeric blend including at least one polymer selected from the group consisting of an ethylene-vinyl-acetate, an ethylene-propylene-diene, a polyethylene-propylene, a urethane, a polyester, an acrylonitrile, a styrene-butadiene, and a co-polymer thereof.

11. A resilient surface covering or surface covering component comprising:
a melt-processed layer adhered to a substrate, said melt-processed layer exhibiting a toughness value of at least 100% greater than a toughness value exhibited by a control melt-processed PVC layer.

12. The resilient surface covering or surface covering component of claim 11, wherein the surface covering or surface covering component is a floor covering or floor covering component.

13. The resilient surface covering or surface covering component of claim 11, wherein the melt-processed layer includes a polymeric blend.

14. The resilient surface covering or surface covering component of claim 13, the melt-processed layer including from about 10% to about 45% by weight of the polymeric blend.

15. The resilient surface covering or surface covering component of claim 13, the polymeric blend including a polyvinyl chloride polymer and at least one compatible polymer.

16. The resilient surface covering or surface covering component of claim 15, the compatible polymer being selected from the group consisting of an acrylonitrile, a urethane, an ethylene-vinyl-acetate, a chlorinated polyethylene, a polyester, and a co-polymer thereof.

17. The resilient surface covering or surface covering component of claim 15, the polymeric blend including about 10% to about 40% by weight of the compatible polymer.

18. The resilient surface covering or surface covering component of claim 11, the substrate being selected from the group consisting of solid filled polymeric layer, solid unfilled polymeric layer, solid filled polymeric composite, solid unfilled polymeric composite, solid layer composite including a fibrous web saturated with polymeric binder, porous fibrous layers, and non-woven fabrics.

19. The resilient surface covering or surface covering component of claim 11, further comprising at least one additional layer adhered to the melt-processed layer, said additional layer being selected from the group consisting of a foamed layer, a wear layer, a pattern layer and a top coat layer.

20. The resilient surface covering or surface covering component of claim 11, the melt-processed layer including at least one polymer selected from the group consisting of an ethylene-vinyl-acetate, an ethylene-propylene-diene, a polyethylene-propylene, a urethane, a polyester, an acrylonitrile, a styrene-butadiene, and a co-polymer thereof.

21. The resilient surface covering or surface covering component of claim 13, the polymeric blend including at least one polymer selected from the group consisting of an ethylene-vinyl-acetate, an ethylene-propylene-diene, a polyethylene-propylene, a urethane, a polyester, an acrylonitrile, a styrene-butadiene, and a co-polymer thereof.

22. A resilient surface covering or surface covering component comprising:
a melt-processed layer attached to a layer selected from the group consisting of a wear layer, a foamed layer, a pattern layer, a substrate and a top coat layer, said melt-processed layer exhibiting a toughness value of at least 100% greater than a toughness value exhibited by a control melt-processed PVC layer.

23. The resilient surface covering or surface covering component of claim 22, wherein the melt-processed layer includes a polymeric blend.

24. The resilient surface covering or surface covering component of claim 23, the melt-processed layer including from about 10% to about 45% by weight of the polymeric blend.

25. The resilient surface covering or surface covering component of claim 23, the polymeric blend including a polyvinyl chloride polymer and at least one compatible polymer.

26. The resilient surface covering or surface covering component of claim 25, the compatible polymer being selected from the group consisting of an acrylonitrile, a urethane, an ethylene-vinyl-acetate, a chlorinated polyethylene, a polyester, and a co-polymer thereof.

27. The resilient surface covering or surface covering component of claim 25, the polymeric blend including about 10% to about 40% by weight of the compatible polymer.

28. The resilient surface covering or surface covering component of claim 22, the melt-processed layer including at least one polymer selected from the group consisting of an ethylene-vinyl-acetate, an ethylene-propylene-diene, a polyethylene-propylene, a urethane, a polyester, an acrylonitrile, a styrene-butadiene, and a co-polymer thereof.

29. The resilient surface covering or surface covering component of claim 23, the polymeric blend including at least one polymer selected from the group consisting of an ethylene-vinyl-acetate, an ethylene-propylene-diene, a polyethylene-propylene, a urethane, a polyester, an acrylonitrile, a styrene-butadiene, and a co-polymer thereof.

30. A surface covering comprising:
a melt-processed layer, the surface covering exhibiting an impact resistance value at least 30% greater than an impact resistance value exhibited by a control surface covering including a control melt-processed PVC layer.

31. The surface covering of claim 30, wherein the surface covering is a floor covering.

32. The surface covering of claim 30, wherein the melt-processed layer includes a polymeric blend.

33. The surface covering of claim 32, the melt-processed layer including from about 10% to about 45% by weight of the polymeric blend.

34. The surface covering of claim 32, the polymeric blend including polyvinyl chloride and at least one compatible polymer.

35. The surface covering of claim 34, the compatible polymer being selected from the group consisting of an acrylonitrile, a urethane, an ethylene-vinyl-acetate, a chlorinated polyethylene, a polyester, and a co-polymer thereof.

36. The surface covering of claim 34, the polymeric blend including about 10% to about 40% by weight of the compatible polymer.

37. The surface covering of claim 30, the melt-processed layer including at least one polymer selected from the group consisting of an ethylene-vinyl-acetate, an ethylene-propylene-diene, a polyethylene-propylene, a urethane, a polyester, a nitrile, a styrene-butadiene, and a co-polymer thereof.

38. The surface covering of claim 32, the polymeric blend including at least one polymer selected from the group consisting of an ethylene-vinyl-acetate, an ethylene-propylene-diene, a polyethylene-propylene, a urethane, a polyester, an acrylonitrile, a styrene-butadiene, and a co-polymer thereof.

39. The surface covering of claim 30, further comprising a wear layer and a top coat layer.

40. The surface covering of claim 30, wherein the surface covering further comprises a foam layer.

41. The surface covering component of claim 30, wherein the surface covering further comprises a substrate.

42. The surface covering of claim 41, wherein the substrate comprises a beater-saturated felt.

43. A surface covering or surface covering component comprising:
a melt-processed layer including a blend of polyvinyl chloride resin and nitrile rubber.

44. The surface covering or surface covering component of claim 43, the melt-processed layer including from about 10% to about 45% by weight of the blend.

45. The surface covering or surface covering component of claim 43, the blend including from about 10% to about 40% by weight of the nitrile rubber.

46. The surface covering or surface covering component of claim 43, the melt-processed layer exhibiting a toughness value at least 100% greater than a toughness value exhibited by a control melt-processed PVC layer.

47. A surface covering or surface covering component comprising:
a multi-layered component including a wear layer adhered to a foam layer adhered to a melt-processed layer including a blend of polyvinyl chloride and nitrile rubber.

48. The surface covering or surface covering component of claim 47, the melt-processed layer including from about 10% to about 45% by weight of the blend.

49. The surface covering or surface covering component of claim 47, the blend including from about 10% to about 40% by weight of the nitrile rubber.

50. The surface covering or surface covering component of claim 47, the melt-processed layer exhibiting a toughness value at least 100% greater than a toughness value exhibited by a control melt-processed PVC layer.

51. The surface covering of claim 47, the multi-layered component exhibiting an impact resistance value at least 30% greater than an impact resistance value exhibited by a control sheet including a control melt-processed PVC layer.

52. A surface covering comprising:
a melt-processed layer exhibiting a toughness value of at least 100% greater than a toughness value exhibited by a control melt-processed PVC layer, the surface covering exhibiting an impact resistance value at least 30% greater than an impact resistance value exhibited by a control surface covering.

53. The surface covering of claim 52, the melt-processed layer including a blend of polyvinyl chloride and nitrile rubber.

54. The surface covering of claim 52, wherein the surface covering is a floor covering.
